(19) United States
(12) Patent Application Publication
(10) Pub. No.: US 2026/0328940 A1
(43) Pub. Date: Oct. 22, 2026

(54) SYSTEMS AND METHODS FOR BIKE INTEGRATED FEEDBACK

(71) Applicant: Also, Inc., Palo Alto, CA (US)

(72) Inventors: Joshua Bayer, Costa Mesa, CA (US); Patrick Harrington, San Francisco, CA (US); Christopher Yu, Menlo Park, CA (US); Remi Anand Durocher, Tustin, CA (US)

(73) Assignee: Also, Inc., Palo Alto, CA (US)

(21) Appl. No.: 19/486,654

(22) PCT Filed: May 31, 2024
(86) PCT No.: PCT/US2024/032134

§ 371 Date: Nov. 21, 2025

Related U.S. Application Data
(60) Provisional application No. 63/505,248, filed on May 31, 2023.

(51) Int. Cl. G01S 15/931; B62J 45/41; B62J 50/21

(52) U.S. Cl. CPC G01S 15/931; B62J 45/41; B62J 50/225

(57) ABSTRACT

Integrated feedback systems for bicycles are provided. A system includes a sensor coupled with a bike to detect an object. The system includes one or more processors, coupled with memory and the sensor. The system determines, via the sensor, a probability that a trajectory of the object intersects with the bike. The system provides, responsive to the probability greater than or equal to a threshold, an alert to a rider of the bike via an indicator located on a handlebar of the bike. The system projects, responsive to the probability greater than the threshold, a visual indication with a light source coupled to the bike to alert a user of the object.

### CROSS REFERENCE TO RELATED APPLICATIONS

This application claims the benefit of and priority to U.S. Provisional Patent Application No. 63/505,248, filed on May 31, 2023, the entirety of which is incorporated by reference herein.

### INTRODUCTION

Bicycles can include an electric motor that receives power from a battery.

### SUMMARY

This technology is generally directed to systems and methods for integrating feedback systems into electric bicycles (e.g., bikes or e-bikes). The feedback system can provide a visual or audio feedback to a rider of the electric bike or operators of other vehicles, bikes or objects that are separate from or proximate to the bike. A bike can include one or more processors and sensors that are configured to provide monitoring for the bicycle and surrounding vicinity. The bike can detect an object, such as a vehicle or another bicycle.

When the bike detects that one or more objects are in proximity to the bike, the bike can perform one or more functions. For example, the object can be in a blind spot of the bike, or the probability of the trajectory of the bike intersecting with the trajectory of the bike can be greater than or equal to a threshold. The blind spot of the bike can refer to or include an area around the bike that is not visible to the rider or user of the bike, and can occur on either side of the bike or behind the bike. These functions can include, for example, presentation of alerts for both a rider of the bike and a user of the object external to the bike (e.g., a driver of a car that is within a predetermined distance from the bike). Thus, this technical solution can notify both the rider of the bike and the user of the object that the object that may be on a collision course with the bike.

At least one aspect is directed to a system. The system can include a sensor coupled with a bike to detect an object. The system can include one or more processors, coupled with memory and the sensor. The one or more processors can determine, via the sensor, a probability that a trajectory of the object intersects with the bike. The one or more processors can provide, responsive to the probability greater than or equal to a threshold, an alert to a rider of the bike via an indicator located on the bike. The one or more processors can project, responsive to the probability greater than the threshold, a visual indication with a light source coupled to the bike to alert a user of the object.

At least one aspect is directed to a method. The method can be performed by one or more processors, coupled with memory, of a bike. The method can include the one or more processors determining, via a sensor of the bike, a probability that a trajectory of an object detected by the sensor intersects with the bike. The method can include the one or more processors providing, responsive to the probability greater than or equal to a threshold, an alert to a rider of the bike via an indicator located on a handlebar of the bike. The method can include the one or more processors projecting, responsive to the probability greater than the threshold, a visual indication with a light source coupled to the bike to alert a user of the object.

At least one aspect is directed to an electric bike. The electric bike can include a sensor to detect an object. The electric bike can include one or more processors, coupled with memory and the sensor. The one or more processors can determine, via the sensor, a probability that a trajectory of the object intersects with the electric bike. The one or more processors can provide, responsive to the probability greater than or equal to a threshold, an alert to a rider of the electric bike via an indicator located on a handlebar of the electric bike. The one or more processors can project, responsive to the probability greater than the threshold, a visual indication with a light source coupled to the electric bike to alert a user of the object.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification. The foregoing information and the following detailed description and drawings include illustrative examples and should not be considered as limiting.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 depicts an example system for integrating feedback systems into bicycles.

FIG. 2 depicts an example electric bicycle.

FIG. 3 depicts an example flow diagram of a method for integrating feedback systems into bicycles.

FIG. 4 depicts an example flow diagram of a method for integrating feedback systems into bicycles.

FIG. 5 depicts an example flow diagram of a method for integrating feedback systems into bicycles.

FIG. 6 depicts an example flow diagram of a method for integrating feedback systems into bicycles.

FIG. 7 depicts an example flow diagram of a method for integrating feedback systems into bicycles.

FIG. 8 depicts an example view of the electric bicycle casting a projection.

FIG. 9 depicts an example view of the electric bicycle with zones.

FIG. 10 depicts an example view of a handlebar of the electric bicycle illustrated in FIG. 2.

FIG. 11 depicts an example view of a handlebar of the electric bicycle illustrated in FIG. 2.

FIG. 12 depicts an example view of a handlebar grip of the electric bicycle illustrated in FIG. 2

FIG. 13 is a block diagram illustrating an architecture for a computer system that can be employed to implement elements of the systems and methods described and illustrated herein.

### DETAILED DESCRIPTION

Following below are more detailed descriptions of various concepts related to, and implementations of, methods, apparatuses, and systems of integrating feedback systems into bicycles. The various concepts introduced above and discussed in greater detail below may be implemented in any of numerous ways.

The subject matter described herein is generally directed to systems and methods for integrating feedback systems into bicycles. A feedback system can include, for example, generating an alert, actuating a light, emitting a siren, among others functions, responsive to a detection of an object by the bicycle. The bicycle can be an electric bicycle (e.g., bike, e-bike) which can detect, through sensors coupled with the bicycle, an object within a proximity to the bicycle, such as a vehicle or another bike. The bike (e.g., including associated logic devices) can determine a probability that a trajectory of the object intersects the bike. That is to say, the bike can determine how likely the object is to collide with the bike. When the bike determines that the object is likely to intersect with the bike, the bike can issue an alert to a rider of the bike, a user of the object, or a combination thereof. The bike can determine the probability responsive to other detected parameters of the bike or object, such as a speed of the bike, a size of the object, or the location of the object. The bike can determine that the object should be classified as a threat. The bike can determine that the object is a threat based on other qualities of the bike or the object, such as a speed of the bike, the location of the object, or a size of the object. When the bike determines that the object is a threat, the probability of the trajectory of the object intersects the bike, or a combination thereof, the bike can alert the rider of the bike. The bike can further alert the user of the object, such as a driver or another bike rider. Thus, this technical solution can provide enhanced monitoring for the rider of the bike, improved communication between the rider of the bike and an operator of the object, and improve battery life of the electric bike, by determining the probability that the trajectory of the object intersects with the bike, providing an alert to the rider of the bike, and projecting a visual indication to alert a user of the object.

The electric bike can be operated in a designated bicycle lane. One or more sensors on the bike can detect a vehicle within a range of the bike. For example, the bike can detect a vehicle behind the bike and approaching the bike. The bike can determine, based on the speed of the vehicle and the location of the vehicle, a potential trajectory of the vehicle. For example, the bike can determine if the vehicle is or will be in a blind spot of the bike, or the bike can determine how likely the vehicle is to collide with the bike. A blind spot of the bike can be a location of the vehicle in relation to the bike that is difficult or cumbersome for the rider of the bike to see or be aware of. A blind spot can cause the rider to remove her eyes from the road to ascertain the location of the vehicle or other object. If the vehicle is in a blind spot of the bike, the bike can alert the rider of the bike. The bike can alert the rider, for example, through a noise, haptic feedback, or a light on the bike. If the vehicle is more likely to have a trajectory that collides with the bike, such as by approaching nearer to the bike, or if the likelihood of collision is otherwise greater than a threshold, the bike can alert the rider of the bike, in a similar but perhaps more urgent manner as described above. For example, the bike can emit a louder alarm, shine brighter or more lights to indicate to the rider, or enact a stronger haptic alert. The user of the vehicle can also be alerted. The user can be alerted by a projection from the bicycle. For example, the bike can project lights, an image, or a hologram towards the vehicle or around the vicinity of the bike to alert the user of an impending collision. In this manner, both the rider of the bike and the user of the object can receive alerts related to the trajectory of the vehicle.

The disclosed solutions have a technical advantage of detecting an object near a bicycle and alerting both the rider of the bike and the user of the object. For example, the bike can alert a rider of the bike, a user of the object, or the combination thereof. The alert can change in intended audience, intensity, or duration based on the determination of the probability of the trajectory of the object intersecting the bike. For example, the alert can alert just the rider of the bike, if the bike determines the object may not intersect the bike but may be in a blind spot of the bike, or the bike can alert the rider of the bike and the user of the object if the bike determines the object to be above a threshold likeliness of the object intersecting the bike. For example, the bike can alert the rider of the bike with an indicator on the handlebar of the bike if the object is likely to pass the bike closely (e.g., between 1′-3′ of the bike), or the bike can alert the rider of the bike with multiple indicators and a haptic system in the handlebars if the object is likely to be within a zone of the bicycles (e.g., 6″-1′ of the bike), or the bike can alert the rider of the bike with multiple indicators and can alert the user of the object using a projection from the bike if the object is likely to strike the bicycle (e.g., 0 ″-6″ of the bike). Such techniques can reduce miscommunications between riders of bikes and operators of vehicles or other bikes, provide a buffer of space around a bike, employ advanced monitoring and feedback to the rider of the bike and the user of the object, and improve battery life of the bike.

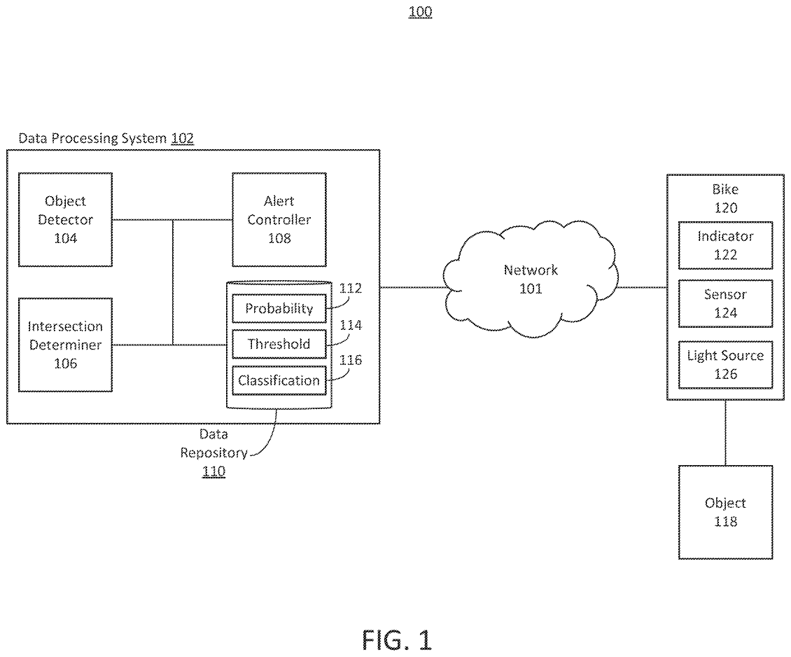

FIG. 1 depicts an example system 100 for integrating feedback systems into bicycles. The system 100 can employ a network 101 to exchange information based on an object and a bike. The system 100 can include, interface with or otherwise communicate with a data processing system 102. The system 100 can include, interface with or otherwise communicate with a bike 120 such as an electric bike 120. The data processing system 102 can be part of, hosted by, or otherwise integrated with a component of the electric bike 120. The system 100 can include, interface with or otherwise communicate with an object 118.

The network 101 can include computer networks such as the Internet, local, wide, metro, or other area networks, intranets, cellular networks, satellite networks, and other communication networks such as Bluetooth, or data mobile telephone networks. The network 101 can be public or private. The various elements of the system 100 can communicate over the network 101.

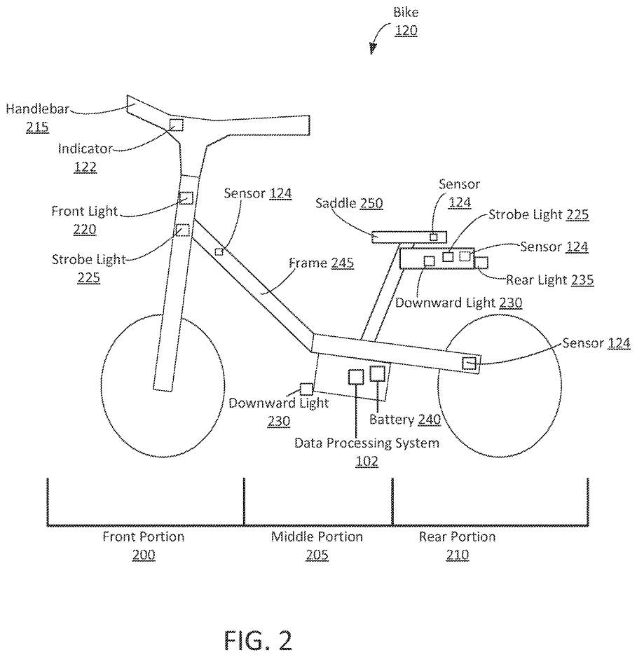

The bike 120 can be an electric bike 120 operable by a rider of the bike. The bike 120 can include one or more indicators 122, sensors 124, or light sources 126. The bike 120 can include further subcomponents described with reference to FIG. 2 herein. The bike 120 can be operable by at least one rider, or the bike 120 can operate autonomously. During operation, the bike 120 can employ indicators 122 to indicate to the rider various operating circumstances. Operating circumstances can include the object 118 approaching or within a distance to the bike 120, a condition of the surface upon which the bicycle 120 is operating, or a condition of a mechanical, electrical, or other subsystem of the bike 120. The indicators 122 can include optical, haptic, or auditory indicators. The indicators 122 can include one or more lights disposed within the bike 120 and visible to the rider. The indicators 122 can include one or more haptic systems, such as a system to apply vibrations, force, motion, or other tangible interface for the rider. The indicators can include one or more speakers, amplifiers, bells, or horns for producing noise audible to the rider or to a user of the object 118. For example, the indicators 122 can include lights and a haptic system disposed within a handlebar (e.g., handlebar 215 described with reference to FIG. 2) of the bike 120 and can include one or more speakers on a rear portion of the bike 120.

The bike 120 can include one or more sensors 124 to detect the operating circumstances of the bike 120. For example, the sensors 124 can detect the proximity of the bike 120 to the object 118, the speed of the bike 120 or the object 118, the size of the object 118, the surface conditions, or an ambient light, among others. The sensors 124 can include sensors for detecting position or distance such as a proximity sensor. Proximity sensors can include ultrasonic sensors, which can detect the distance between the bike 120 and the object 118 using ultrasonic sound waves. For example, the ultrasonic sensor 124 can propagate ultrasonic pulses which reflect off the object 118 back to the sensor 124 to detect the distance between the sensor 124 (of the bike 120) and the object 118.

The sensors 124 can include camera sensors or other sensors to detect the size of the object 118. Other sensors to detect the size of the object 118 can include ultrasonic sensors 124 as described herein, whereby the ultrasonic waves or pulses of the sensor 124 can indicate the size of the object 118. Camera sensors can include optical sensors (such as diffuse reflection sensors or photodiodes) or image recognition devices. The sensors 124 can include optical sensors to detect environmental conditions such as the surface conditions or the ambient light. For example, the sensors 124 can detect the slipperiness of the surface of a road on which the bike 120 is operating by detecting the reflectivity of the surface using the optical sensor 124.

The bike 120 can include one or more light sources 126 to indicate or alert a user of the object 118. The light sources 126 can be or include any hardware or software to display projections on the surface of the road upon which the bike 120 is operating. The projections can refer to or include a solid light directed in any direction from the bike, a strobing or flashing light, or a pattern or image (e.g., arrows or boundaries). The light sources 126 can include at least lights, filters, a lens, or a micro-lensing array (MLA) light sources to generate and display the projection on the surface of the road. MLA light sources can be a projector for casting images on the surface of the road and can include one or more light-emitting diodes (LEDs), one or more collimators, or an array of micro-lenses. The light sources can include or be like components of FIG. 2, such as a front light 220, a strobe light 225, a downward light 230, or a rear light 235. For example, the downward light 230 of the bike 120 can be a MLA light source, or the rear light 235 of the bike 120 can include LEDs.

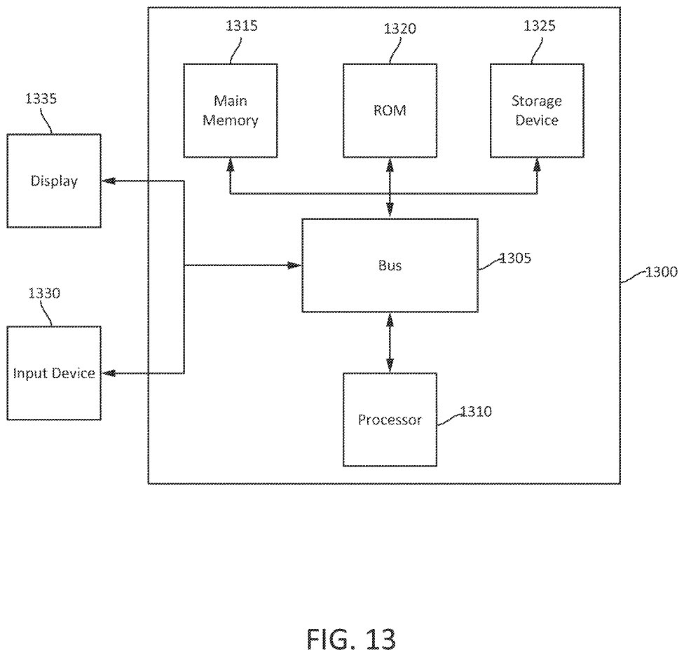

The data processing system 102 can include or be disposed within the bike 120. The data processing system 102 can be remote from the bike 120 and configured to communicate with the bike 120 through the network 101. The data processing system 102 can include at least one object detector 104. The data processing system 102 can include at least one intersection determiner 106. The data processing system 102 can include at least one alert controller 108. The data processing system 102 can include at least one data repository 110. The object detector 104, the intersection determiner 106, or the alert controller 108 can each include at least one processing unit or other logic device such as programmable logic array engine, or module configured to communicate with the data repository 110 or a database. The object detector 104, the intersection determiner 106, or the alert controller 108 can be separate components, a single component, or part of the bike 120. The data processing system 102 can include hardware elements, such as one or more processors, logic devices, or circuits. For example, the data processing system 102 can include one or more components or structures of functionality of computing devices depicted in FIG. 13.

The data repository 110 can be any memory, storage, or cache for storing information or data structures that facilitates the data processing system 102 or the bike 120 to integrate feedback and alerts into the bike 120. The data repository 110 can contain any information about the system 100 and can allow that information to be accessed by any components of the data processing system 102, such as by communication methods described herein. The information or data structures contained within the data repository 110 can be dynamic and can change periodically (e.g., daily or every millisecond), via an input from a user, via information from the bike 120, or via inputs from subcomponents of the data processing system 102 The data repository 110 can include one or more local or distributed databases, and can include a database management system. The data repository 110 can include computer data storage or memory and can store one or more data structures, such as a probability 112, threshold 114, or a classification 116.

The probability 112 can refer to or include a probability that a trajectory of the object 118 intersects with the bike 120. The object 118 can be at a location or moving at a speed detectable by the sensors 124. The data (e.g., speed or location) indicated by the sensors 124 can be used to determine one or more potential trajectories of the object 118. The probability 112 can be a likelihood that the object 118 will enter a specified distance of the bike 120. The probability 112 can include multiple probabilities 112 of the object 118 being within specified distances of the bike 120 or at a specific location in relation to the bike 120. For example, the probability 112 can include a probability of 0.1 that the object 118 passes the bike 120 with more than 4′ between the object 118 and the bike 120, a probability of 0.4 that the object 118 will be between 3′-4′ of the bike 120, a probability of 0.4 that the object 118 will be between 1.5′-3′ of the bike 120, and a probability of 0.1 that the object 118 will be between 0′-1.5′ of the bike 120.

The probability 112 can refer to one probability of the object 118 intersecting the bike 120. For example, the probability 112, based on a determined trajectory of the object 118, can be 0.2 that the object 118 intersects with the bike 120. Intersecting with the bike 120 can include a collision with the bike 120, coming within a threshold distance of the bike 120, or crossing with an intended path or trajectory of the bike 120. Crossing with an intended path or trajectory of the bike 120 can include the object 118 pulling over immediately in front of the bike 120, a door of the object 118 opening into the direction of travel of the bike 120, or the object 118 making a right hand perpendicularly into the direction of travel of the bike, among others. Each probability of the probability 112 can be subject to the threshold 114.

The threshold 114 can be or include a threshold probability, distance, size, or time for the object 118 in relation to the bike 120. The threshold 114 can be configured to allow the data processing system 102 to trigger a response or action when the threshold 114 is met or exceeded. For example, the data processing system 102 may provide an alert to the rider, the user of the object 118, or a combination thereof if the probability 112 is greater than or equal to the threshold 114. The threshold 114 may be pre-determined, or configured by the rider of the bike 120. The rider of the bike 120 can establish a threshold 114 area, boundary, perimeter, or zone around the bike 120. For example, the rider of the bike 120 can establish a zone around the bike that is 3′ in radius, or the rider of the bike can establish a zone which differs in distance around the bike 120.

The threshold 114 probability can be a threshold for a singular probability 112 that the trajectory of the object 118 may intersect the bike 120. For example, the probability 112 that the object 118 intersects the bike 120 can be 0.8, and the threshold 114 probability that the object 118 intersects the bike 120 can be 0.2. In this case, the threshold 114 is exceed by the probability 112. The threshold 114 can be a threshold probability as related to the distance between the bike 120 and the object 118. For example, the threshold 114 can be a threshold probability of 0.2 for the object 118 passing the bike 120 with between 1′-2′ of the bike 120. The threshold 114 can be unsurpassable. For example, the threshold 114 can be 1.1 for the object 118 passing the bike 120 with more than 4′ between the object 118 and the bike 120. In this illustrative example, any probability 112 indicating that the object 118 will pass the bike 120 with 4′ or more distance between the bike 120 and the object 118 cannot exceed the threshold 114. The threshold 114 can relate to a size of the object 118. For example, the threshold 114 may correspond to a planar area of the object 118, a volume of the object 118, or a height or width of the object 118.

A classification 116 can be or include a tag, annotation, or identifier for the object 118. The classifications 116 can be numerical, a string, or other form of classification. The classifications 116 can include a human readable or machine based label. For example, the classifications 116 can include classifications for the object 118 such as “threat,” “potential threat,” or “non-threat.” The classifications may be numerical, such as “1, 2, 3, 4.” The classification 116 of the object 118 can be based on the probability 112 and the threshold 114. For example, if the probability 112 is greater than or equal to the threshold 114, the object 118 may be classified as a “threat.” The classification can correspond to a size of the object 118. For example, a classification of “threat” can be associated with an object 118 possessing a height between a threshold 114 height of 5′-8′. In this manner, each classification 116 can correspond to at least a relation between the probability 112 and the threshold 114. The classification 116 can be configured to allow the data processing system 102 to trigger a response or action, such as an alert for the rider or the user of the object 118, when the object 118 is associated with a certain classification 116. For example, the data processing system 102 may provide an alert to the rider, the user of the object 118, or a combination thereof if the object 118 is classified as a “threat.”

The object 118 can be an object which can travel alongside or impede the bike 120. The object 118 cab be an automatic object or an object operable by a user. The object 118 can be or include, for example, a vehicle, another bicycle, a scooter, a pedestrian, or road debris. A vehicle can include a passenger vehicle, a commercial vehicle, a bus, a train, or components thereof, such as doors, trunks, or side view mirrors. For example, the object 118 can include a door of a parked vehicle when the door opens such that it may impede the rider of the bike 120. The object 118 can be stationary or in motion. For example, the object 118 may be a parked vehicle, or may be a vehicle travelling in the same direction as the bike 120, travelling perpendicularly or at another angle to the bike 120, or travelling towards the bike 120 (e.g., as in a contraflow bike lane).

The data processing system 102 can include at least one object detector 104 designed, constructed, or operational to determine parameters of the object 118 or the bike 120. Parameters of the object 118 can include at least a speed of the object 118, a location of the object 118, or a size of the object 118. For example, the object detector 104 can detect, via the sensors 124, that the object 118 is 10′ from the bike 120. For example, the object detector 104 can detect, via the sensors 124, that the object 118 is travelling at 30 MPH. For example, the object detector 104 can detect, via the sensors 124, that the object 118 is 5′ wide and 7′ tall. Responsive to detecting one or more parameters of the object 118, the object detector 104 can store the parameters in the data repository 110. The object detector 104 can convey the location to another portion of the data processing system 102.

The object detector 104 can include or communicate with one or more sensors 124 to detect the object 118 and its parameters. For example, the object detector 104 can receive data related to the object 118 from the sensors 124. The object detector 104 can receive the data from the sensors 124 via the network 101, or via a hardwired connection through the bike 120. The object detector 104 can determine, from the data received from the sensors 124, the parameters of the object 118 or the bike 120, such as location, speed, and size. For example, the object detector 104 can receive a location or distance from an ultrasonic sensor of the sensors 124 to determine the location of the object 118 in relation to the bike 120. The object detector 104 can determine a speed of the object 118 from at least a change in location of the object 118 over a period of time (e.g., dead reckoning). The object detector 104 can determine a speed of the bike 120 based at least on the sensors 124, such as via an accelerometer or speedometer of the sensors 124. For example, the object detector 104 can determine a size of the object 118 from data from an ultrasonic sensor of the sensors 124 denoting a volume, height, width, or planar area of the object 118.

The object detector 104 can determine if the object 118 is located in a zone established for the bike 120. A threshold 114 zone can be established for the bike 120 by the rider of the bike or as a predetermined threshold 114. The threshold 114 zone can be as described herein. The zone can be an area or perimeter around the bike 120, or the zone can be an established bike lane or traffic area for the bike 120, detectable by the sensors 124. The object detector 104 can, through the sensors 124, determine that the object 118 is located in the zone establish for the bike 120.

The object detector 104 can associate the object 118 with a classification 116 by the detected object 118 parameters. For example, the object detector 104 can determine the size of the object 118 from readings from the sensors 124 and classify the object 118 using the size of the object 118. For example, the object detector 104 can determine if the object 118 is a threat based at least on the size of the object 118. For example, if the size of the object 118 is within a threshold 114 range of size, the object detector 104 can associate the object 118 with the classification 116 of “threat.” For example, if the size of the object 118 is within a second threshold 114 range of size, the object detector 104 can associate the object 118 with a second classification 116 of “non-threat” or perhaps “potential threat.” In some cases, if the object detector 104 does not classify the object 118 as a “threat,” the data processing system 102 can block a determination of the probability 112 by the intersection determiner 106. For example, the object detector 104 can associate a classification 116 of “non-threat” to the object 118 responsive to the object 118 being less than or equal to a threshold 114. The object detector 104 cannot associate a classification 116 with the object 118, but can still determine that the size of the object 118 is at or below a threshold. If the object detector 104 determines the object 118 to be classified as a “non-threat” responsive to being at or below a threshold 114 size or if the object 118 is determined by the object detector 104 to be at or below a threshold 114 size, the data processing system 102 can block the probability 112 determination by the intersection determiner 106.

The data processing system 102 can include at least one intersection determiner 106 designed, constructed, or operational to determine, calculate, assess, or establish a probability that a trajectory of the object 118 intersects with the bike 120. The probability that a trajectory of the object 118 intersects with the bike 120 can refer to or be like the probability 112. The intersection determiner 106 can accept parameters from the object detector 104 such as the speed, size, or location of the object 118 or the bike 120. In this manner, the intersection determiner 106 can use the sensors 124 as input to make a determination of the probability 112.

The intersection determiner 106 can assess the parameters of the object 118 and the bike 120 to calculate one or more probabilities 112. For example, the intersection determiner 106 can determine a trajectory of the object 118 based at least on the location of the object 118 and a speed or acceleration of the object 118. The intersection determiner 106 can calculate the trajectory, for example, by predicting a straight-line path of the object 118 based on the speed, acceleration, location, or combination thereof of the object 118. The intersection determiner 106 can calculate the trajectory of the object 118 using a different predicted trajectory than a straight-line path, such as a meandering or curved trajectory.

The intersection determiner 106 can determine a trajectory of the bike 120. The intersection determiner 106 can determine the trajectory of the bike 120 in a similar manner as determining the trajectory of the object 118. For example, the intersection determiner 106 can assess the bike's current location, speed, acceleration, or combination thereof to determine an estimated trajectory of the bike 120 based on its current parameters.

Based on the determined trajectory of the object 118 and the bike 120, the intersection determiner 106 can determine the probability 112 that the object 118 and the bike 120 intersect. For example, the intersection determiner 106 can determine a probability 112 of 0.4 that the bike 120 and the object 118 intersect. The intersection determiner 106 can determine the probability 112 that the bike 120 and the object 118 come within a specified distance of each other. For example, the intersection determiner 106 can determine a first probability 112 that the bike 120 and the object 118 intersect, a second probability 112 that the object 118 passes or comes within a specified distance of the bike 120, or a third probability 112 that the object passes or comes outside of a specified distance of the bike 120, such as the zone established for the bike 120.

In some cases, the intersection determiner 106 can determine the probability 112 responsive to other conditions determined by the object detector 104. For example, the intersection determiner 106 can determine the probability 112 responsive to a determination by the object detector 104 that the size of the object 118 is between a threshold 114 size. For example, the intersection determiner 106 can determine the probability 112 responsive to the object detector 104 detecting a speed of the bike 120 greater than or equal to a threshold 114 speed.

The intersection determiner 106 can determine that the probability 112 is at or above the threshold 114 probability. For example, the intersection determiner 106 can determine that the calculated probability 112 exceeds or is equal to the threshold 114 probability. The intersection determiner 106 can make the determination of the probability 112 exceeding or equal to the threshold 114 using one or more of a comparator, processor, transistors, or other hardware or software to determine a threshold met or exceeded. Responsive to the determination that the probability 112 is at or above the threshold, the intersection determiner 106 can generate a set of instructions for the alert controller 108.

The intersection determiner 106 can generate a set of instructions for the alert controller responsive to a determination that the probability 112 is greater than or equal to the threshold 114. The intersection determiner 106 can generate the set of instructions responsive to other conditions determined by the object detector 104. For example, the intersection determiner 106 can generate the set of instructions responsive to a determination by the object detector 104 that the object 118 is a threat, or that the object 118 is within a threshold 114 size. The intersection determiner 106 can generate the set of instructions responsive to a determination by the object detector 104 and responsive to the determination that the probability 112 is at or exceeds a threshold 114 probability. For example, the intersection determiner 106 can generate the set of instruction for the alert controller responsive to a determination by the intersection determiner 106 that the probability 112 is at or exceeds the threshold 114 probability and responsive to a determination by the object detector 104 that the object 118 is in a the zone established for the bike 120.

The data processing system 102 can include at least one alert controller 108 designed, constructed, or operational to generate and provide, project, or display one or more alerts for the rider of the bike 120, the user of the object 118, or a combination thereof. The alert controller 108 can receive, from the intersection determiner 106, a set of instructions.

The set of instructions can include information or data related to the satisfaction of any of the thresholds 114, the conditions, the classifications 116, the parameters of the bike 120 or the object 118, an amount by which any of the thresholds 114 were exceeded, or any other information determined or collected by the object detector 104 and the intersection determiner 106.

The alert controller 108 can provide an alert to the rider of the bike 120. The alert controller 108 can provide the alert responsive to the intersection determiner 106 determining that the probability 112 exceeds the threshold 114. The alert controller 108 can provide the alert responsive to a condition determined by the object detector 104, such as a classification of “threat” or the determination that the size of the object 118 is between a threshold 114 size. The alert controller 108 can provide the alert responsive to a combination of the determinations by the intersection determiner 106 and the object detector 104. The alert can be provided via the indicator 122 of the bike 120. For example, the alert can be a flashing of a light of the indicator 122, a buzzing of a haptic system of the indicator 122, a sound emitted from a speaker of the indicator 122, or any combination of functions of the indicators 122.

The alert can be or include a ring lighting device coupled to a handlebar of the bike 120. For example, the alert can display via a series of lights disposed within the handlebar 215, as described with reference to FIG. 2.

The alert controller 108 can generate and display an alert for the user of the object 118 via the light source 126 or the indicators 122. For example, responsive to the probability 112 being greater than or equal to the threshold 114, the alert controller can actuate the light source 126 to provide a visual indication to the user of the object 118. The visual indication can be a projection, flashing or steady lights, an image, or any of the visual indications described in reference to the light source 126. The user of the object 118 can have the light source 126 displayed to him to indicate to the user of the object 118 that the current trajectory of the object 118 may intersect with the trajectory of the bike 120.

The alert for the rider and for the user of the object 118 can vary dependent at least upon the set of instructions. The alert may be tiered. As an illustrative example, the alert can be a first tier alert to indicate to the rider of the bike 120 via one light of the ring lighting device if the object detector 104 classifies the object 118 as a “non-threat.” The alert can be a second tier alert to indicate to the rider of the bike 120 via more than one light or haptic feedback if the object 118 is classified as a “potential threat.” The alert can be a third tier alert to indicate to the rider and the user of the object 118 (via the light source 126) if the object detector 104 classifies the object 118 as a “threat.” As another illustrative example, the alert controller 108 may provide an alert to the rider of the bike 120 and the user of the object 118 responsive to a determination by the intersection determiner 106 that the probability 112 is at or exceeding the threshold 114, and can provide an alert to only the rider of the bike 120 if the intersection determiner 106 determines the object 118 to be in the blind spot of the rider or the probability 112 to be at or below the threshold 114.

Thus, by detecting an object 118, the data processing system 102 can determine the probability 112 that the trajectory of the object 118 can intersect with the bike 120. The data processing system 102 can determine that the probability 112 is at or exceeding the threshold 114 and can generate an alert based at least on the probability 112 for the rider of the bike 120, the user of the object 118, or a combination thereof. The system 100 can provide improved communication between the rider and the user of the object 118, improve battery life of the electric bike 120, and enable advanced monitoring and feedback systems for the rider of the electric bike 120.

FIG. 2 depicts an example cross-sectional view of an electric bike 120 installed with at least one battery pack 240. Electric bike 120 can include single rider bicycles, tandem bicycles, cargo bicycles, motor-assist bicycles, pedicabs, electric-assist bicycles, road bicycles, mountain bicycles, or unicycles, among others. The battery pack 240 can also be used as an energy storage system to power a building, such as a residential home or commercial building. The bike 120 can be fully electric or partially electric (e.g., pedal-powered) and further, the electric bike 120 can be fully autonomous, partially autonomous, semi-autonomous, or unmanned. The electric bike 120 can also be human operated or non-autonomous. A human operator or the rider of the bike 120 can sit on a saddle 250 to operate the bike 120. The rider of the bike 120 can steer, grip, balance, or otherwise control the bike 120 using the handlebar 215. The handlebar 215 can include one or more indicators 122 to alert the rider of the bike. For example, the indicators 122 may include a ring lighting device and a haptic system to alert the rider of the bike 120.

The electric bike 120 can be fully autonomous and autonomously navigate, drive, or propel itself with or without a human operator or rider sitting on the bike or otherwise being in contact with the bike. The electric bike 120 can autonomously navigate with or without the human operator or rider controlling the electric bike 120. In some cases, the electric bike 120 can be partially autonomous by, for example, assisting the human operator or rider to ride the bike. For example, the electric bike 120 can autonomously control, navigate, steer, or propel or more the electric bike 120 in certain conditions, scenarios, or responsive to certain events. In some cases, the electric bike 120 can autonomously control, navigate, steer or propel the electric bike 120 during one or more segments of a route set for the electric bike 120. For example, the electric bike 120 can be configured to autonomously drive, navigate, or propel the electric bike 120 when the electric bike 120 is traversing a straight path or road. The electric bike 120 can include a cruise control functionality or an adaptive cruise control functionality.

To do so, the electric bike 120 can include sensors, control units, control functions, communication modules, or other components configured to achieve autonomous navigation, powered by an electric motor. For example, the electric bike 120 can include an accelerometer, gyroscope, or magnetometers that can provide data on the motion of the electric bike 120, orientation, or heading. The electric bike 120 can use this information stabilization, path planning, or control function.

The electric bike 120 can be configured with one or more control systems or functions to facilitate decision-making or autonomous navigation. The control system can process data from the one or more sensors execute control functions to determine navigation actions. For example, an object detection and tracking function an use computer vision to analyze the visual input from the cameras and identify objects of interest such as vehicles, pedestrians, and traffic signs. The electric bike 120 can tracks these objects to determine the movements of the objects, and avoid potential collisions. The electric bike 120 can include a path planning and navigation control function to generate routes for the electric bike 120, considering factors such as traffic conditions, road regulations, and rider preferences. The electric bike 120 can include collision avoidance control functions that can use, for example, data from LiDAR, radar, or vision sensors. The collision avoidance control functions can assess the surrounding of the electric bike 120 and calculate evasive actions when potential hazards are detected. The collision avoidance control functions can autonomously navigate the electric bike 120 in various scenarios to maintain a predetermined distance from obstacles.

The electric bike 120 can include a communication module to connect with external systems via a network. These modules include wireless communication technologies such as Wi-Fi, Bluetooth, and cellular connectivity. The electric bike 120 can integrate with a companion mobile application or a central control center, allowing riders to monitor and customize riding experience, receive real-time updates, and access additional features. The electric bike 120 can use communication module or companion mobile application or control center to receive instructions for a route, and autonomously or semi-autonomously navigate the electric bike 120 along the route.

The electric bike 120 can provide one or more levels of autonomous driving (e.g., levels 0 to 5). For example, level 0 can refer to no automation in which the electric bike 120 is entirely controlled by a human driver, and there is no automation present. All aspects of driving, including steering, acceleration, braking, and monitoring the environment, can be performed by the driver without any assistance from the systems of the electric bike 120 in level 0.

In level 1, the systems of the electric bike 120 can provide assistance to the driver in controlling the vehicle. These systems focus on a single function, such as adaptive cruise control or lane-keeping assistance. However, the driver can retain full responsibility for operating the electric bike 120 during level 1.

In level 2, the electric bike 120 can provide partial automation via multiple advanced driver assistance systems (ADAS) that can control two or more primary functions of the electric bike 120. For example, a system may combine adaptive cruise control with lane-keeping assistance. However, the rider can be responsible for monitoring the riding environment and be ready to take control of the electric bike 120 at any time.

In level 3, the electric bike 120 can provide conditional automation in which the electric bike 120 can take full control of the driving tasks under specific conditions and environments. The rider can relinquish control and engage in non-driving-related activities, but can intervene when the system requests intervention. The automation system of the electric bike 120 can manage most driving functions, but the rider can be available to resume control within a reasonable time frame when prompted.

In level 4, the electric bike 120 can provide high automation or greater automation relative to levels 2 and 3 by performing all driving tasks within certain predefined conditions and environments without rider intervention. The system can handle most situations independently, and the presence of the rider can be optional (e.g., the rider may sit on the bike seat but may not control any riding function of the bike). Level 4 automation can be limited to specific operational domains, such as geographic areas, weather conditions, or road types.

In level 5, the electric bike 120 can be configured to provide full automation, where the electric bike 120 can perform all driving tasks under any conditions and environments that a human driver could handle. The electric bike 120, when operating at level 5, may not have a human rider sitting on the bike or the human rider may not perform or provide any intervention for driving. The electric bike 120 can operate autonomously in various scenarios, including complex urban environments, highways, rural roads, trails, bike paths, dirt roads, or parks.

The bike 120 can include a frame 245. The frame 245 can support various components of the bike 120, such as a handlebar 215, the indicators 122, a saddle 250, the sensors 124, the battery 240, a front light 220, a strobe light 225, a downward light 230, or a rear light 235. The frame 245 can span a front portion 200. The front portion 200 can support, be coupled with, or include, for example, a front wheel of the bike 120, a fork of the bike 120, the handlebar 215, the front light 220, or the strobe light 225, among other components. The bike 120 can include two or more wheels. The frame 245 can span a middle portion 205. The middle portion 205 can support, be coupled with, or include, for example, the saddle 250, the sensor 124, the battery 240, a crank shaft of the bike 120, or a pedal of the bike 120, among other components. The frame can include a rear portion 210.

The rear portion 210 can support, be coupled with, or include, for example, a rear wheel of the bike 120, the sensors 124, the rear light 235, the downward light 230, a drive train of the bike 120, or a rack of the bike 120, among other components.

The bike 120 can include battery packs 240 which can include batteries, battery modules, or battery cells power the electric bike 120. The battery 240 can be installed or placed within the bike 120. For example, the battery 240 can be installed on the frame 245 of the bike 120 within one or more of the front portion 200, the middle portion 205, or the rear portion 210. The battery 240 can include or connect with at least one busbar, e.g., a current collector element. For example, the busbar can include electrically conductive material to connect or otherwise electrically couple the battery 240 with other electrical components of the bike 120 to provide electrical power to various systems or components of the bike 120, such as the light source 126 (including the downward light 230, the strobe light 225, the front light 220, and the rear light 235), the indicator 122, or the data processing system 102.

The bike 120 can provide a user interface, such as a graphical user interface or an audio-based user interface. The user interface can include, interface with, or otherwise utilize a touchscreen, keyboard, buttons, knobs, other user interface input devices 1330 or display 1335 depicted in FIG. 13, for example. Through the user interface, the rider of the bike can input one or more thresholds 114, view operating parameters of the bike 120, or control components of the bike 120, among other actions.

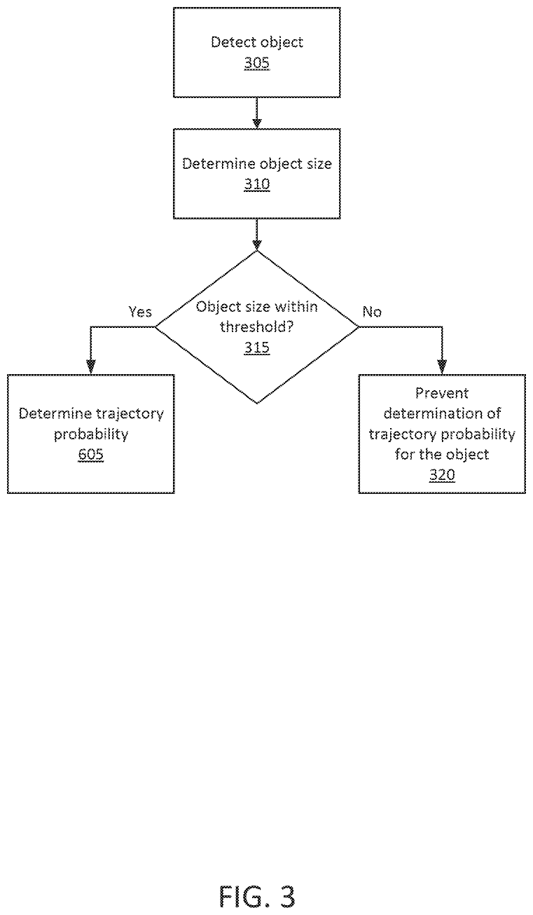

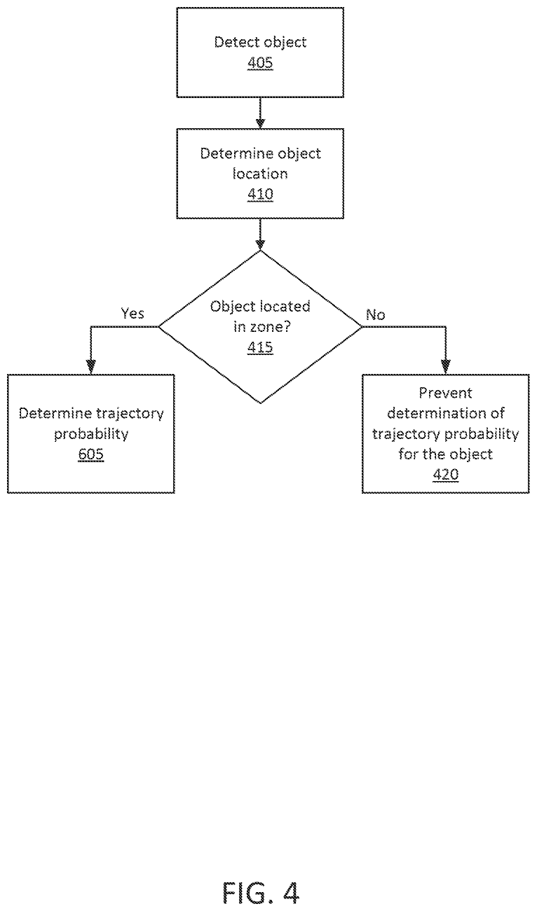

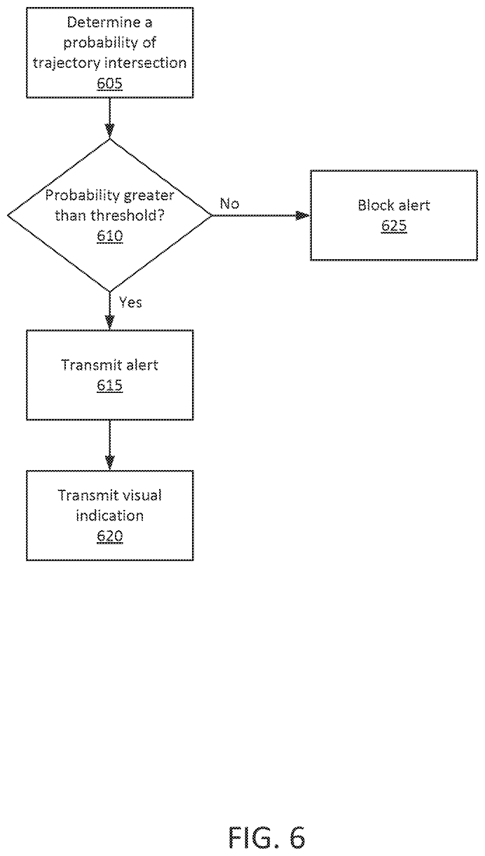

FIGS. 3, 4, 5, and 6 each depict an example flow diagram of a method for integrating feedback systems into bicycles. Each of the methods 300, 400, 500, and 600 can be performed sequentially, consecutively, in combination, or alone. In some cases, one method flow may occur responsive to another method flow. For example, the method flows 300 and 400 may occur concurrently prior to the occurrence of the method flow 600. The described acts of each of FIGS. 3, 4, 5, and 6 can occur in different orders. For example, ACT 405 of FIG. 4 can occur subsequent to ACT 410 of FIG. 4. For example, ACT 620 of FIG. 6 can occur before ACT 615 of FIG. 6. The methods 300, 400, 500, and 600 can be performed by one or more systems or component depicted in FIG. 1, FIG. 2 or FIG. 13, including, for example, a data processing system or a bike.

Referring now to FIG. 3, at ACT 305, the data processing system of the bike can detect an object. At ACT 310, the data processing system can determine a size of the object. At ACT 315, the data processing system can determine if the object size is within a threshold. If the data processing system determines that the object size is within a threshold, then the data processing system can proceed to ACT 605 of FIG. 6. If the data processing system determines that the size of the object is not within the threshold, then the data processing system can proceed to ACT 320. At ACT 320, the data processing system can prevent the determination of the trajectory probability for the object. For example, if the size of the object is less than the threshold size, then the object may be too small for the trajectory of the object to have an impact on the bike 120. The probability of a trajectory intersection can include or refer to the probability 112 of FIG. 1. The data processing system can prevent, terminate, skip, or ignore the determination of the probability by, for example, not classifying the object as a threat, by not relaying the determination of object detection to other components of the data processing system, or by generating a signal or instructions to not actuate an alert or determine the probability. The data processing system can prevent the determination for a first object not within the size threshold, and can allow the determination for a second object within the size threshold.

In FIG. 4 at ACT 405, the data processing system of the bike can detect an object. At ACT 410, the data processing system can determine a location of the object. At ACT 415, the data processing system can determine if the object is within a zone. The zone can be like or refer to the zone established by the bike 120, described herein. If the data processing system determines that the object is located within the zone, then the data processing system can proceed to ACT 605 of FIG. 6, described herein. If the data processing system determines that the location of the object is not within the zone, then the data processing system can proceed to ACT 420. At ACT 420, the data processing system can prevent a determination of a probability of a trajectory intersection for the object. The probability of a trajectory intersection can be like or refer to the probability 112 of FIG. 1. The data processing system can prevent the determination of the probability by, for example, not classifying the object as a threat, by not relaying the determination of object detection to other components of the data processing system, or by generating a signal or instructions to not actuate an alert or determine the probability. The data processing system can prevent the determination for a first object not located within a zone, and can allow the determination for a second object located within the zone.

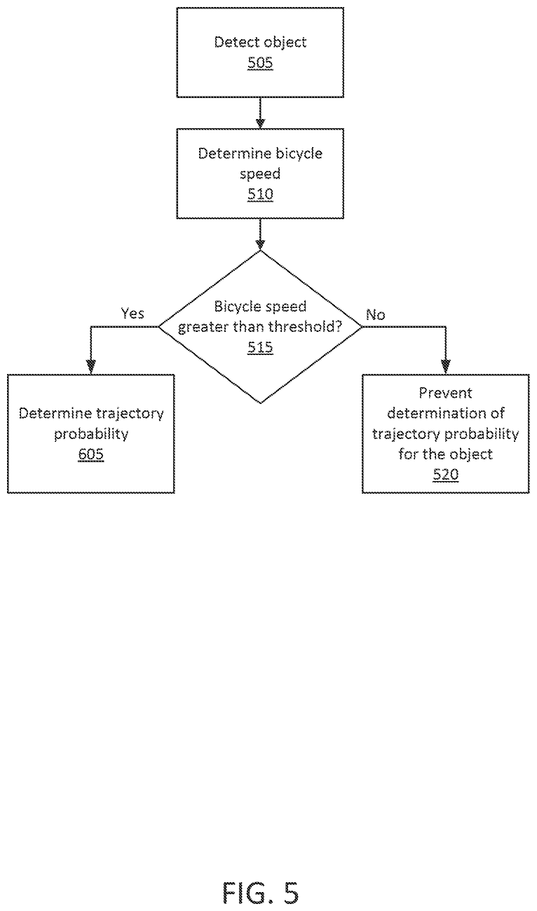

In FIG. 5, at ACT 505 the data processing system of the bike can detect an object. At ACT 510, the data processing system can determine a speed of the bike. At ACT 515, the data processing system can determine if the speed of the bike is greater than a threshold speed. If the data processing system determines that the bike is operating at a speed greater than or equal to a threshold, then the data processing system can proceed to ACT 605 of FIG. 6, described herein. If the data processing system determines that the speed of the bicycle does not exceed the threshold, then the data processing system can proceed to ACT 520. At ACT 520, the data processing system can prevent a determination of a probability of a trajectory intersection for the object. The probability of a trajectory intersection can be like or refer to the probability 112 of FIG. 1. The data processing system can prevent the determination of the probability by, for example, not classifying the object as a threat, by not relaying the determination of object detection to other components of the data processing system, or by generating a signal or instructions to not actuate an alert or determine the probability. The data processing system can prevent the determination for a first object when the bicycle speed is not greater than the threshold, and can allow the determination for a second object when the bicycle speed is greater than the threshold.

The method flow 600 of FIG. 6 can be responsive to any of the method flows 300, 400, or 500, or the method flow 600 can stand alone. At ACT 605, the data processing system determines a probability of trajectory intersection. At ACT 610, the data processing system determines whether the probability is greater than a threshold probability. If the data processing system does not determine that the probability is greater than the threshold probability, the data processing system can proceed to ACT 625. At ACT 625, the data processing system blocks an alert. The alert can be an alert to a rider of a bike, a user of an object, or to both. If the data processing system determines that the probability is greater than the threshold, the data processing system can proceed to ACT 615. At ACT 615, the data processing system transmits an alert. The alert can be transmitted to the rider of the bike responsive to a determination by the data processing system that the probability of the trajectory of the object intersecting the bike is greater than a threshold. At ACT 620, the data processing system can transmit a visual indication. The visual indication can be transmitted to alert a user of the object that the data processing system has determined that the probability of the trajectory of the object intersecting the bike is greater than a threshold. In this manner, the visual indication can alert the user of the object to correct his course to avoid the intersection of the object and the bike.

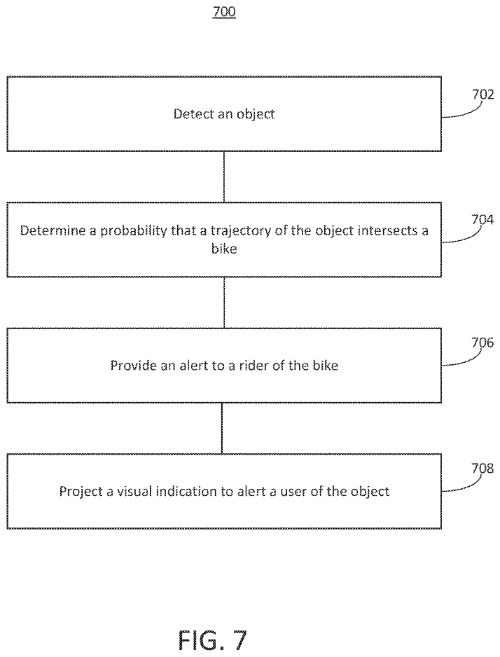

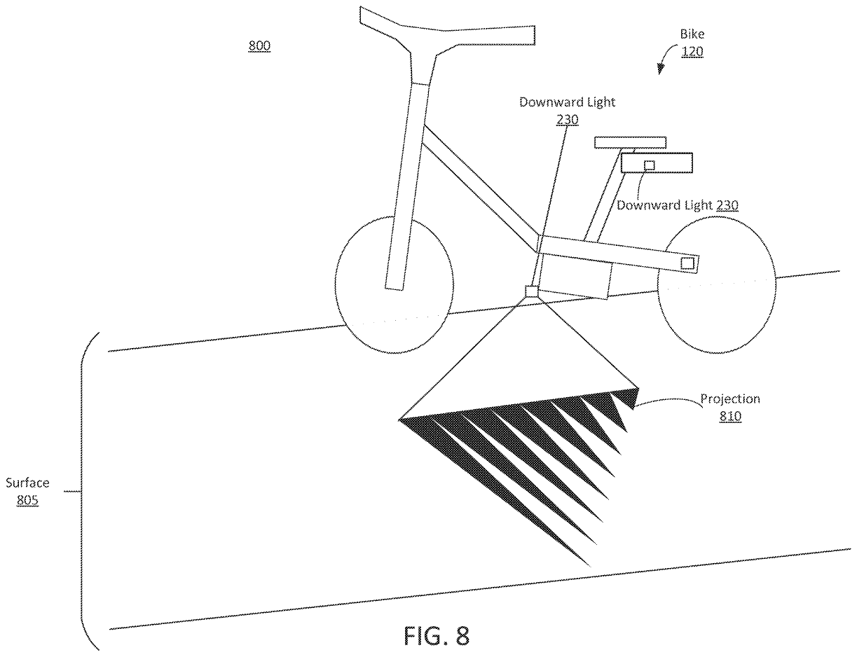

FIG. 7 depicts an example flow diagram of method for integrating feedback systems into bicycles. The method 700 can be performed by one or more system or component depicted in FIG. 1, FIG. 2 or FIG. 8, including, for example, a data processing system or bike. At ACT 702, the data processing system can detect an object. At ACT 704, the data processing system can determine a probability that a trajectory of the object intersects a bike. At ACT 706, the data processing system can provide an alert to a rider of the bike. The data processing system can provide an alert to the rider of the bike responsive to the data processing system determining that the probability is at or exceeds a threshold probability. At ACT 708, the data processing system can project a visual indication to alert a user of the object.

FIG. 8 depicts an example view 800 of the electric bicycle 120 casting a projection. The bike 120 can cast a projection 810 onto a surface 805 using its lights, such as the downward light 230. The bike 120 may cast, project, emit, or illuminate the projection 810 to alert the rider of the bike 120, a user of an object, other bystanders, operators of other vehicles or other bikes, or a combination thereof. The bike 120 can emit the projection 810 responsive to a detection of the object being classified as a threat. For example, the bike 120 can cast the projection 810 onto the surface 805 to warn, alert, or get the attention of the user of the object. The bike can emit the projection 810 responsive to the object being within a threshold size or distance, or above a threshold probability of intersection. For example, the bike 120 can emit the projection 810 responsive to a determination that the probability of the object intersecting the bike 120 is above a threshold probability. The bike 120 can emit the projection 810 responsive to a determination that the object has entered one or more zones of the bike 120. The bike 120 can emit the projection 810 on a schedule, such as from 6 PM to 6 AM. The bike 120 can emit the projection 810 based on a command from the rider of the bike 120. For example, the rider of the bike 120 can select (e.g., from a user interface of the bike or a handlebar of the bike) to cast the projection 810.

The projection 810 can be any display to alert a user of an object or a rider of the bike 120. The projection 810 can be a light display, a shadow, a hologram, among others, cast from a light of the bike 120. The projection 810 can be any shape, figure, text, color, or shape. The projection 810 can change shape, intensity, size, orientation, placement, or periodicity. For example, the projection 810 can increase in size or can blink at different rates. The projection 810 can change in response to an input from the rider of the bike 120, a change in the alert, a detection of an object, or a change in a classification of an object, among others. In some cases, a first projection can correspond to a first object within a threshold size, distance, classification, probability of trajectory intersection, speed, or other quality, and a second projection can correspond to a second object different from the first. In this manner, the projection 810 can correspond to different conditions the rider of the bike 120 can encounter to alert the rider and a user of the object.

The light sources of the bike 120 can emit the projection 810. For example, the downward light 230 of the bike 120 can emit the one or more projections 810. Though not pictured, the light sources (e.g., the light source 126 of FIG. 1) can include components of FIG. 2, such as the front light 220, the strobe light 225, or the rear light 235. The light of the bike (e.g., the downward light 230) can be a projector, such as a micro lensing array projector, described herein. The downward light 230 can cast the light at varying distances. For example, the downward light 230 can cast a first projection 810 at a distance of ten feet from the bicycle 120, and the rear light 235 can cast a second projection 810 at a distance of three feet from the bicycle 120.

The downward light 230 can cast the projection 810 onto the surface 805. The surface 805 can be any road, sidewalk, curb, or object within a proximity of the downward light 230. The surface 805 can vary in shape, size, orientation, texture, or reflectivity. As an illustrative example, the downward light 230 can cast a projection 810 onto a road and the back of a vehicle. The projection 810 may be visible on the road and the back of the vehicle. In this example, the back of the vehicle and the road are both the surface 805 onto which the projection 810 can be viewed.

In this manner, the bike can alert the rider of the bike with multiple indicators and can alert the user of the object using the projection 810 from the bike 120 for various scenarios. For example, if the object is likely to strike the bicycle (e.g., 0″-6″ of the bike), the lights of the bike 120 can automatically emit a projection 810 to warn the rider of the bike 120 and the user of the object. The use of the projections 810 on the surface 805 can provide a buffer of space around the bike 120 by alerting users of objects, pedestrians, or others.

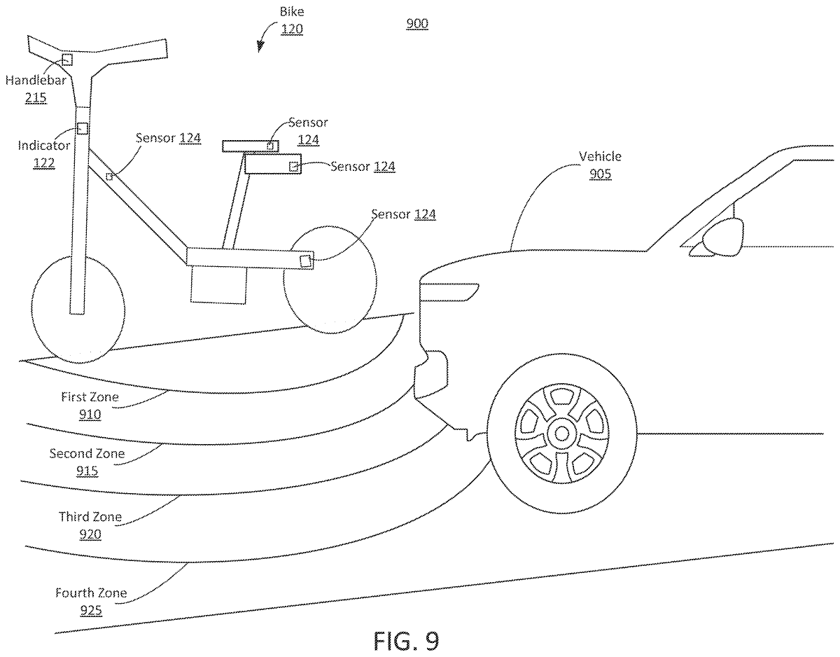

FIG. 9 depicts an example view 900 of the electric bike 120 with zones. As described herein, the bike 120 can establish zones around the bike 120. The zones can include a first zone 910, a second zone 915, a third zone 920, or a fourth zone 925. A vehicle 905 can enter one or more of the zones 910-925. The sensors 124 of the bike 120 can detect that an object (e.g., the vehicle 905) has entered one or more zones of the bike 120. The bike 120 can alert a rider of the bike that the vehicle 905 has entered the one or more zones 910-925 through, for example, the indicator 122 on the handlebar 215 of the bike 120.

The zones 910-925 can be any defined perimeter, region, or area around the bike 120. The zones can be preset, established by a rider of the bike 120, or can be determined from existing surfaces, such as an established bicycle lane. The zones 910-925 can correspond to different thresholds for the bike 120. For example, the first zone 910 can be associated with a low threshold for the probability that the trajectory of the vehicle 905 will intersect with the bike 120, and the fourth zone 925 can be associated with a high threshold for the probability that the trajectory of the vehicle 905 will intersect with the bike 120. The zones 910-925 can correspond to different classifications. For example, an object which enters the first zone 910 or the second zone 915 can be classified as a “threat,” and an object which enters the third zone 920 or the fourth zone 925 may not be classified as a “threat.”

The zones 910-925 can overlap or intersect one another. For example, the second zone 915 can overlap with the third zone 920 in part or entirely. The zones 910-925 can be different shapes than each other. For example, the first zone 910 can be a rectangular shape and the third zone 920 can be an elliptical shape. In some cases, the shape or area of the zones 910-925 can be determined from road conditions. For example, the sensors 124 can detect a flex post or the painted surface of a bike lane. The bike 120 can then establish a zone corresponding to the bike lane. The zones 910-925 can include a zone within a blind spot of the rider of the bike 120. For example, the third zone 920 can include an area difficult for the rider of the bike 120 to see while travelling forward.

The sensors 124 can detect the vehicle 905 entering the one or more zones 910-925. The sensors 124 can determine that the vehicle 905 (or another object) has entered at least one of the zones by determining a first distance from the bike encompassed by each zone of the zones 910-925. The sensors 124 can detect that the vehicle 905 is a second distance from the bike 120. The data processing system can compare the distance that the vehicle 905 is from the bike 120 to the zones 910-925. If the vehicle 905 is within one or more of the zones 910-925, the bike 120 can alert the rider, the user of the vehicle 905, or both. The bike 120 can alert the rider using the indicator 122 of the handlebar 215. For example, upon the vehicle 905 entering one or more zones, the indicator 122 can vibrate to alert the rider of the bicycle 120 that a vehicle 905 is within one or more zones. The bike 120 can alert the user of the vehicle 905. For example, the bike 120 may emit a projection (such as projection 810 described with reference to FIG. 8) to alert the user of the vehicle 905 that he is within a zone of the bicycle 120. Alerts can vary in intensity, duration, or audience based on the zone in which the vehicle 905 has entered. For example, the vehicle 905 entering the third zone 920 can cause the indicator 122 to vibrate to warn just the rider of the bike 120, and the vehicle 905 entering the first zone 910 can cause the bike to emit a sound from the indicator 122 and to emit a projection. In summary, the alerts can change dependent on the zone broached by the vehicle 905.

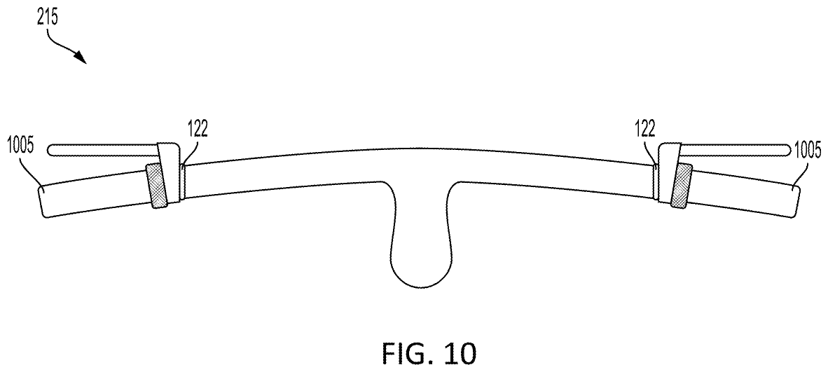

FIG. 10 depicts an example view of the handlebar 215. The handlebar 215 can include a first indictor 122 and a second indicator 122. As shown in FIG. 10, the first indicator 122 and the second indicator 122 include at least one light source (e.g., light emitting diodes (LEDs), bulbs, etc.). The first indicator 122 and the second indictor 122 can produce or emit light to provide feedback to a user or rider of the bike 120. For example, the first indicator 122 can be located proximate to a left side of the handlebar 215. The first indicator 122 can produce light to indicate a detection of an object proximate to the left side of the ride of the bike 120. As another example, the first indicator 122 can produce light that varies in brightness based on a distance between an object an the bike 120. Stated otherwise, the first indicator 122 can produce light with a first brightness based on an object being in the first zone 910 and can produce light a second brightness based on the object being in the second zone 915.

The handlebar 215 can include at least one grip 1005 or handlebar grip 1005. The grip 1005 can provide a surface or an area for a rider of the bike 120 to place their hands.

The grip 1005 can include at least one interface or other computing device to communicate with the data processing system 102. For example, the grip 1005 can be electrically coupled with the data processing system 102.

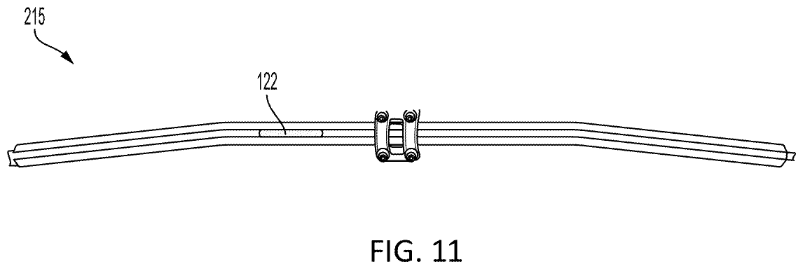

FIG. 11 depicts an example view of the handlebar 215. The handlebar 215 can include the indicator 122. As shown in FIG. 11, the indicator 122 can extend or travel across the handlebar 215. The indicator 122 can produce light at various points across the handlebar 215. For example, the indicator 122 can produce light that travels or moves from a first side of the handlebar 215 to a second side of the handlebar 215. As another example, the indicator 122 can produce with various colors to indicate distances between the bike 120 and one or more objects. The indicator 122 can produce light with a first color based on an object being in the third zone 920 and the can produce light with a second color based on the object being the fourth zone 925.

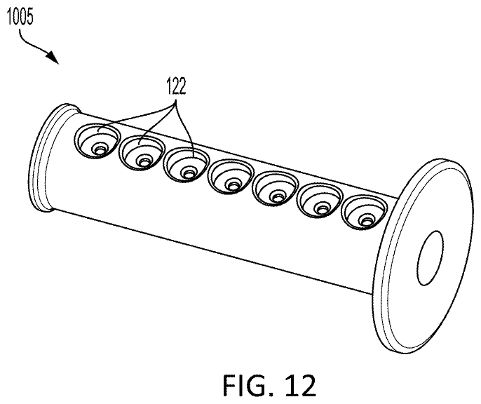

FIG. 12 depicts an example view of the grip 1005. The grip 1005 can include the indictor 122. For example, the indicator 122 can be disposed within one or more openings or apertures of the grip 1005. The indicator 122 can provide haptic feedback to a rider of the bike 120. For example, the indicator 122 can vibrate or produce motion to inform a rider of the bike 120 that an object was detected proximate to the bike 120. The indicator 122 can vary and/or alter the haptic feedback based on a distance between the bike 120 and the object. For example, the indicator 122 can increase an amount of vibration as an object moves closer to the bike 120. Stated otherwise, the indictor 122 can increase the haptic feedback as objects move closer to the bike 120.

FIG. 13 is a block diagram illustrating an architecture for a computer system that can be employed to implement elements of the systems and methods described and illustrated herein, including, for example, the systems depicted in FIG. 1, FIG. 2, FIG. 8, and FIG. 9, and the methods depicted in FIG. 3, FIG. 4, FIG. 5, FIG. 6, and FIG. 7. The computing system 1300 can include at least one bus 1305 or other communication component for communicating information and at least one processor 1310 or processing circuit coupled to the bus 1305 for processing information. The computing system 1300 can also include one or more processors 1310 or processing circuits coupled to the bus for processing information. The computing system 1300 also includes at least one main memory 1315, such as a random access memory (RAM) or other dynamic storage device, coupled to the bus 1305 for storing information, and instructions to be executed by the processor 1310. The main memory 1315 can be used for storing information during execution of instructions by the processor 1310. The computing system 1300 may further include at least one read only memory (ROM) 1320 or other static storage device coupled to the bus 1305 for storing static information and instructions for the processor 1310. A storage device 1325, such as a solid state device, magnetic disk or optical disk, can be coupled to the bus 1305 to persistently store information and instructions.

The computing system 1300 may be coupled via the bus 1305 to a display 1335, such as a liquid crystal display, or active matrix display, for displaying information to a user such as a rider of the bike 120 or other end user. An input device 1330, such as a keyboard or voice interface may be coupled to the bus 1305 for communicating information and commands to the processor 1310. The input device 1330 can include a touch screen display 1335. The input device 1330 can also include a cursor control, such as a mouse, a trackball, or cursor direction keys, for communicating direction information and command selections to the processor 1310 and for controlling cursor movement on the display 1335.

The processes, systems and methods described herein can be implemented by the computing system 1300 in response to the processor 1310 executing an arrangement of instructions contained in main memory 1315. Such instructions can be read into main memory 1315 from another computer-readable medium, such as the storage device 1325. Execution of the arrangement of instructions contained in main memory 1315 causes the computing system 1300 to perform the illustrative processes described herein. One or more processors in a multi-processing arrangement may also be employed to execute the instructions contained in main memory 1315. Hard-wired circuitry can be used in place of or in combination with software instructions together with the systems and methods described herein. Systems and methods described herein are not limited to any specific combination of hardware circuitry and software.

Some of the description herein emphasizes the structural independence of the aspects of the system components or groupings of operations and responsibilities of these system components. Other groupings that execute similar overall operations are within the scope of the present application. Modules can be implemented in hardware or as computer instructions on a non-transient computer readable storage medium, and modules can be distributed across various hardware or computer based components.

The systems described above can provide multiple ones of any or each of those components and these components can be provided on either a standalone system or on multiple instantiation in a distributed system. In addition, the systems and methods described above can be provided as one or more computer-readable programs or executable instructions embodied on or in one or more articles of manufacture. The article of manufacture can be cloud storage, a hard disk, a CD-ROM, a flash memory card, a PROM, a RAM, a ROM, or a magnetic tape. In general, the computer-readable programs can be implemented in any programming language, such as LISP, PERL, C, C++, C #, PROLOG, or in any byte code language such as JAVA. The software programs or executable instructions can be stored on or in one or more articles of manufacture as object code.

Example and non-limiting module implementation elements include sensors providing any value determined herein, sensors providing any value that is a precursor to a value determined herein, datalink or network hardware including communication chips, oscillating crystals, communication links, cables, twisted pair wiring, coaxial wiring, shielded wiring, transmitters, receivers, or transceivers, logic circuits, hard-wired logic circuits, reconfigurable logic circuits in a particular non-transient state configured according to the module specification, any actuator including at least an electrical, hydraulic, or pneumatic actuator, a solenoid, an op-amp, analog control elements (springs, filters, integrators, adders, dividers, gain elements), or digital control elements.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices include cloud storage). The operations described in this specification can be implemented as operations performed by a data processing apparatus on data stored on one or more computer-readable storage devices or received from other sources.

The terms “computing device”, “component” or “data processing apparatus” or the like encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data can include non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The subject matter described herein can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or a combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms.

References to at least one of a conjunctive list of terms may be construed as an inclusive OR to indicate any of a single, more than one, and all of the described terms. For example, a reference to “at least one of ‘A’ and ‘B” can include only ‘A’, only ‘B’, as well as both 'A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

Further relative parallel, perpendicular, vertical or other positioning or orientation descriptions include variations within +/−10% or +/−10 degrees of pure vertical, parallel or perpendicular positioning. References to “approximately,” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

What is claimed is:

1. A system, comprising:
a sensor, coupled with a bike, to detect an object;
one or more processors, coupled with memory and the sensor, to:
determine, via the sensor, a probability that a trajectory of the object intersects with the bike;
provide, responsive to the probability being greater than or equal to a threshold, an alert via an indicator located on a handlebar of the bike; and
project, responsive to the probability greater than the threshold, a visual indication with a light source coupled to the bike to alert a user of the object.

2. The system of claim 1, wherein the sensor comprises an ultrasonic sensor.

3. The system of claim 1, comprising the one or more processors to:
receive data corresponding to the object detected by the sensor;
determine, based on the data, a size of the object; and
determine, responsive to the size of the object being within a threshold range, to provide the alert to a rider of the bike and the visual indication to the user of the object responsive to classification of the object as a threat.

4. The system of claim 1, comprising a plurality of sensors coupled to the bike, and the one or more processors to:
determine a second size of a second object based on a number of the plurality of sensors that detected the second object; and
block determination of a second probability that a second trajectory of the second object intersects with the bike based on the second size of the second object less than or equal to the threshold.

5. The system of claim 1, comprising the one or more processors to:
determine the object is located in a zone established for the bike; and
provide the alert to a rider of the bike and the visual indication to the user of the object responsive to the object located in the zone and the probability of that the trajectory intersects with the bike greater than or equal to the threshold.

6. The system of claim 1, comprising the one or more processors to:
determine, via the sensor, the probability responsive to a speed of the bike greater than or equal to a second threshold.

7. The system of claim 1, comprising the one or more processors to:
generate the alert to provide via the indicator via at least one of a ring lighting device coupled to the handlebar or a haptic device coupled to the handlebar.

8. The system of claim 1, wherein the light source comprises a micro-lensing array projector.

9. A method, comprising:
determining, by one or more processors and memory coupled to a bike, via a sensor of the bike, a probability that a trajectory of an object detected by the sensor intersects with the bike;
providing, by the one or more processors, responsive to the probability greater than or equal to a threshold, an alert to a rider of the bike via an indicator located on a handlebar of the bike; and
projecting, by the one or more processors responsive to the probability greater than the threshold, a visual indication with a light source coupled to the bike to alert a user of the object.

10. The method of claim 9, wherein the sensor comprises an ultrasonic sensor.

11. The method of claim 9, comprising:
receiving, by the one more processors, data corresponding to the object detected by the sensor;
determining, by the one more processors based on the data, a size of the object; and
determining, by the one more processors responsive to the size of the object being within a threshold range, to provide the alert to the rider and the visual indication to the user of the object responsive to classification of the object as a threat.

12. The method of claim 9, wherein a plurality of sensors are coupled to the bike, comprising:
determining, by the one or more processors, a second size of a second object based on a number of the plurality of sensors that detected the second object; and
blocking, by the one or more processors, determination of a second probability that a second trajectory of the second object intersects with the bike based on the second size of the second object less than or equal to the threshold.

13. The method of claim 9, comprising:
determining, by the one or more processors, the object is located in a zone established for the bike; and
providing, by the one or more processors, the alert to the rider and the visual indication to the user of the object responsive to the object located in the zone and the probability of that the trajectory intersects with the bike greater than or equal to the threshold.

14. The method of claim 9, comprising:
determining, by the one or more processors via the sensor, the probability responsive to a speed of the bike greater than or equal to a second threshold.

15. The method of claim 9, comprising:
generating, by the one or more processors, the alert to provide via the indicator via at least one of a ring lighting device coupled to the handlebar or a haptic device coupled to the handlebar.

16. The method of claim 9, wherein the light source comprises a micro-lensing array projector.

17. An electric bike, comprising:
a sensor, coupled with the electric bike, to detect an object;
one or more processors, coupled with memory and the sensor, to:
determine, via the sensor, a probability that a trajectory of the object intersects with the electric bike;
provide, responsive to the probability greater than or equal to a threshold, an alert to a rider of the electric bike via an indicator located on a handlebar of the electric bike; and
project, responsive to the probability greater than the threshold, a visual indication with a light source coupled to the electric bike to alert a user of the object.

18. The electric bike of claim 17, wherein the sensor comprises an ultrasonic sensor.

19. The electric bike of claim 17, comprising the one or more processors to:
receive data corresponding to the object detected by the sensor;
determine, based on the data, a size of the object; and
determine, responsive to the size of the object being within a threshold range, to provide the alert to the rider and the visual indication to the user of the object responsive to classification of the object as a threat.

20. The electric bike of claim 17, comprising a plurality of sensors coupled to the electric bike, and the one or more processors to:
determine a second size of a second object based on a number of the plurality of sensors that detected the second object; and
block determination of a second probability that a second trajectory of the second object intersects with the bike based on the second size of the second object less than or equal to the threshold.
